(19) United States
(12) Patent Application Publication
(10) Pub. No.: US 2009/0159589 A1
(43) Pub. Date: Jun. 25, 2009

(54) Household Appliance, Preferably Cooking Hob

(75) Inventors: Franz Grätz, Traunwalchen (DE); Uwe Has, Unterneukirchen (DE); Andreas Marbach, Traunwalchen (DE); Peter Vetterl, Grabenstätt (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/227,316

(22) PCT Filed: May 14, 2007
(86) PCT No.: PCT/EP2007/054616

§ 371 Date: Nov. 12, 2008

(30) Foreign Application Priority Data
May 19, 2006 (DE) 10 2006 023 702.1

(51) Int. Cl. H05B 3/68

(52) U.S. Cl. 219/445.1

(57) ABSTRACT

A household appliance is provided that includes a functional element that a user can see and includes as well as display elements or control elements for actuating or monitoring the functional element. The display elements and the control elements are disposed where the associated functional element is located.

The invention relates to a domestic appliance, preferably to a cooktop, with at least one functional element that the user can see and with display and/or control elements for actuating or monitoring said functional element.

In electrical domestic appliances such as cooktops, the functional elements, such as electrically-heated hotplates and non-heated induction cooking zones, are spaced relatively far away from their control elements such as switching and control elements, and display elements such as signal lamps and acoustic signal generators, which are usually arranged on the front side of the cooktop in a control panel. The user must thus have a mental picture of the assignment of the functional elements to the display and/or control elements, which is facilitated by a meaningful distribution of these elements corresponding to the arrangement of the functional elements in the cooktop.

In a known cooktop (DE 199 60 495 C1) a temperature sensor positioned approximately in the corner of the cooktop, which is embodied in an approximately dome shape and extends in the operating position from an opening of the cooktop, e.g. a glass ceramic plate, and in the rest position can be retracted to rest flush with the hotplate, is provided as an additional functional element which reacts to infrared radiation emanating from the hotplate. Switching on the temperature sensor, selecting the desired cooking setting and such like is undertaken on the aforementioned front side control panel. In the same way the progress of the cooking process is signaled to the user on the control panel.

The underlying object of the present invention is to design a domestic appliance of the aforementioned type so that a maximum degree of logical assignment between functional elements and associated display and/or control elements is obtained.

This object is achieved for a domestic appliance by the display and/or control elements being arranged at the location of the associated functional element. The attention of the user is thus drawn, without any other mental activity, to that functional element which is to be operated/actuated or controlled or at which, as a result of a signaled malfunction (warning signal), immediate intervention, e.g. switching off, is necessary. This makes it possible to provide the user with guidance through which the user is shown directly and unmistakably in his field of vision the location which demands his attention and/or his action. Applicable functional elements are especially those for which a mechanical, manual actuation or movement is necessary, such as with movable device parts, doors, flaps, sensors of the type mentioned at the start or similar, but also stationary functional elements such as hotplates, especially induction hotplates, which can be provided with a signal-emitting illumination ring for example. An especially advantageous application of the invention is characterized by the functional element being a sensor device which can be moved manually from a rest position lowered into the cooktop into an operating position projecting from the cooktop level and is arranged in a cooktop for non-contact detection of the wall temperature of a cooking pot placed on the cooktop emitting heat energy. In the sense of an embodiment of the display and/or control elements as components of the functional element it is advantageous for the sensor device to feature an at least partly dome-shaped housing able to be lowered into a cooking zone of the cooktop, in which housing an infrared sensor system connected to a control device is arranged behind a housing window aligned to the cooking pot as well as optical and/or acoustic signal elements for the display of the operating state of the sensor device in the housing and/or to be provided in the immediate vicinity of the latter.

In accordance with a preferred embodiment the retractable housing is supported movably in a stationary mounting part and display and/or control elements are arranged both in the housing and also in the mounting part. Display elements can be provided on the movable part of the functional element, preferably after actuation of the latter, while display elements identifying the position of the functional element in the cooktop can be provided in the stationary part, preferably by an element of the stationary mounting part provided directly or indirectly on the surface of the cooking zone being equipped with a preferably circular signaling element surrounding the retractable housing.

In accordance with an advantageous embodiment of the invention the retractable housing has optical display and/or operating elements, especially signal elements, at least on its upper delimiting part, also visible in the retracted position. Such display and/or control elements can also be embodied as switching elements for example and display elements in particular can also be arranged below the upper delimiting part of the retractable housing on its shaft visible in the operating position.

When optical signal generators are used, especially for the display elements, it is advantageous for the display and/or control elements to be made of a light-transmitting material and to be embodied as lighting elements especially in connection with light emitting diodes or, in respect of the displacablity between the stationary mounting part of the sensor device and its mobile part, namely the housing, for the lighting elements to be connected by means of optical fibers to a central light source.

Further advantageous embodiments of the invention emerge from variants relating to the visibility of the display and control elements, e.g. from the fact that the optical display and/or control elements are assigned devices for interrupting the light, i.e. by flashing or color changes and/or that the display and/or control elements are assigned acoustic signal generators, e.g. buzzers.

The invention is explained below with reference to an exemplary embodiment shown in the drawing.

The figures are as follows:

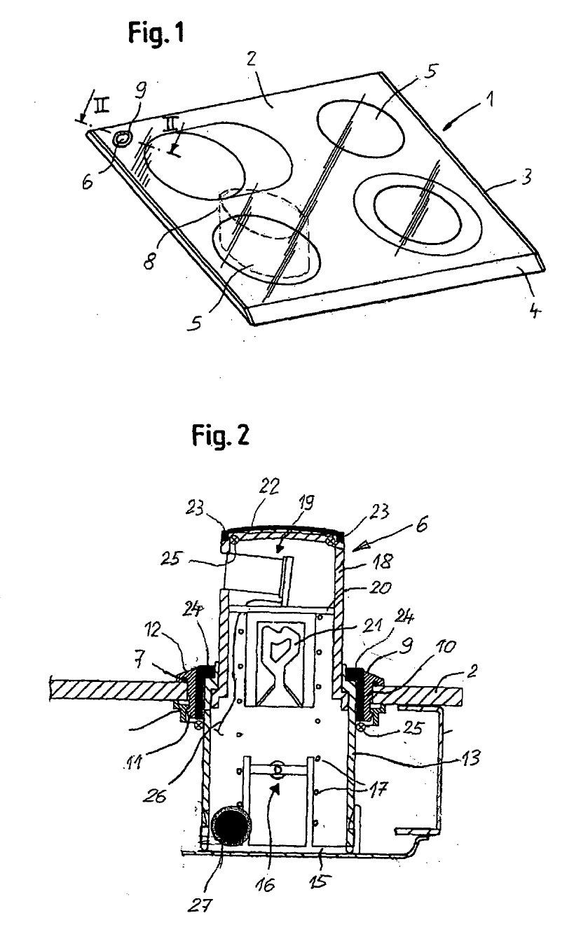

FIG. 1 the perspective diagram of a cooktop,

FIG. 2 an enlarged cross-sectional view of a functional element embodied as a sensor device in accordance with the line II-II in FIG. 1.

A cooktop 1 in accordance with FIG. 1 features a glass ceramic plate 2, to both sides of which metallic edge strips 3 are attached. At its front side the glass ceramic plate 2 ends in a plate facet 4, on or in which in commercially-available cooktops a display and/or control panel is arranged. Provided on the glass ceramic plate 2 are four heatable hotplates 5 marked by the corresponding decor. Below the glass ceramic plate 2 are heating elements known per se assigned to the hotplates 5, so-called radiant heating elements. By selecting corresponding power levels the heating power of the heating elements is set by a control unit of the cooktop 1 in a manner known per se. Mounted retractably in the rear corner area of the cooktop 1 in an opening 7 (FIG. 2) of the glass ceramic plate 2 is a sensor device 6. The basic structure and basic function of the sensor device 6 is known from publication DE 195 37 909 A1. In its operating position the sensor device 6 can for example detect the temperature of a cooking vessel 8 shown in the figure by dashed lines placed on the corresponding hotplate 5, or the outer wall temperature of said vessel. The sensor device 6 transmits the measured temperature value to the control unit not shown in the figure of the cooktop 1, which in its turn controls the heating element of the cooktop accordingly. In this case the sensor device 6 can determine both the cooking vessel temperatures for gas, induction or radiant hotplates and can also measure other temperatures relevant to hotplates of all types. Placed in the circular plate opening 7 of the glass ceramic plate 2 from above is an e.g. metallic ring 9. The ring 9 has a cylinder wall 10 extending below the glass ceramic plate 2, with the ring's end section below the plate having a latching element 11. On the upper side of the plate the ring 9 has a collar 12 which extends inwards and outwards on its circumference, which on the outer side covers the upper plate edge in the area of the plate opening 7 and rests on the glass ceramic plate 2.

The sensor device 6 in accordance with FIG. 2 has a tubular mounting part 13 which in the area of a plate upper side protrusion is pressed via a seal onto the lower side of the collar 12 of the ring 9. Embodied on a base 15 snapped onto the lower end section of the mounting part 13 is a latching device 16 known per se. In addition a compression spring 17 is supported on the base 15, in which the energy is stored for automatic movement of the sensor device 6, i.e. of the housing 18 from its rest position below the glass ceramic plate (FIG. 1) into the operating position above the glass ceramic plate 2 (FIG. 2). Guided to allow vertical movement in the mounting part 13 is a dome-shaped housing 18. Arranged in the housing 18 is an infrared sensor system 19 which detects incident radiation arriving through a window in the housing 18 and transforms it into a suitable measuring signal. The infrared sensor system 19 is connected via an electrical lead 26 to a cooktop control unit 1 not shown in the diagram. Attached below a dividing wall 20 of the housing 18 running in parallel to the floor 15 is a heart-shaped guiding slide 21 known per se. This acts together with latching device 16 and guarantees after light pressure on the cover plate 22 of the housing 18 the automatic deployment of the sensor device 6 as well as retaining the housing 18 in its rest position if the housing 18 is pushed correspondingly far down inside the cooktop.

As indicated in FIG. 2, a circular display element 23 surrounding its cover plate 22 is arranged at the upper end of the housing 18. In a similar manner the inner part of the ring 9 is embodied as an annular display element 24. Assigned to the each of the two display elements 23, 24 embodied as light rings and consisting of a light-conducting material is a light emitting diode 25 as a light source in each case. Of course it can be advantageous to arrange display elements on the shaft visible in the operating position of the housing 18 below the cover plate 22. Furthermore the functional element, i.e. the sensor device 6 in the example, can be provided with one or more control elements, e.g. with an on/off switch in the area of the cover plate 22. Finally the functional element can also have acoustic signal generators e.g. a buzzer 27 as well as devices for interrupting the light by flashing or through color changes, different coloring of the display and suchlike, with not only the position and the operability of the functional element being displayed, but further signals e.g. in relation to setpoint temperature value, warning signals for overtemperature or other user alerts also able to be made visible or audible to the user. The signals necessary for activating the displays can be issued by a central control device of the cooktop 1 or can be initiated by a small control unit in the functional element.

1-12. (canceled)

13. An appliance, preferably an appliance in the configuration of a cooktop, the appliance comprising:
a functional element visible to a user; and
a related element configured as at least one of a display element for monitoring the functional element and a control element for the actuation of the functional element, the related element being disposed at the location of the functional element.

14. The appliance as claimed in claim 13, wherein the display element or the control element is a part of the functional element.

15. The appliance as claimed in claim 13, wherein the functional element can be moved manually or by a motor.

16. The appliance as claimed in claim 13, wherein the functional element is a sensor device arranged in a cooktop for non-contact detection of the wall temperature of a cooking vessel radiating heat energy placed on the cooktop and is able to be moved from a lowered rest position within the cooktop into an operating position projecting above the level of the cooktop.

17. The appliance as claimed in claim 13, wherein the functional element is a sensor device that includes a dome shaped housing able to be retracted into a cooking zone of the cooktop, in which housing an infrared sensor system connected to a control device is arranged behind a housing window aligned to the cooking pot as well as optical and/or acoustic signal elements for the display or for the operating state being provided in the housing and/or being assigned in the immediate vicinity thereof.

18. The appliance as claimed in claim 17, wherein the retractable housing is supported to enable it to move within a stationary mounting part and display and/or control elements are arranged in the housing and/or in the mounting part.

19. The appliance as claimed in claim 16, wherein a ring provided on the surface of the cooking zone as a direct or indirect part of a stationary mounting part is provided for a retractable housing of the sensor device with an annular signal element surrounding the housing.

20. The appliance as claimed in claim 16, wherein the sensor device includes a retractable housing at least on its upper delimiting part, also visible in the retracted setting, that includes optical display and/or control elements especially signal elements.

21. The appliance as claimed in claim 13, wherein the display and/or control elements are embodied as a light unit consisting of light-conducting material, the light sources of which are preferably light emitting diodes.

22. The appliance as claimed in claim 21, wherein the light units are connected by means of optical fibers to a central light source.

23. The appliance as claimed in claim 13, wherein the optical display and/or control elements are assigned facilities for interrupting the light, i.e. through flashing or through color change.

24. The appliance as claimed in claim 13, wherein the display and/or control elements are assigned acoustic signal generators e.g. buzzers.
